(19) United States
(12) Patent Application Publication
(10) Pub. No.: US 2025/0357622 A1
(43) Pub. Date: Nov. 20, 2025

(54) POWER STORAGE DEVICE

(71) Applicant: TOYOTA JIDOSHA KABUSHIKI KAISHA, Aichi-ken (JP)

(72) Inventors: Shigeyuki INOUE, Toyota-shi (JP); Kazuki SUGIE, Miyoshi-shi (JP); Yuki TAKAHASHI, Miyoshi-shi (JP)

(21) Appl. No.: 19/051,172

(22) Filed: Feb. 12, 2025

(30) Foreign Application Priority Data
May 15, 2024 (JP) 2024-079227

(51) Int. Cl. H01M 50/30; H01M 50/289; H01M 50/317

(52) U.S. Cl. CPC H01M 50/394; H01M 50/289; H01M 50/317

(57) ABSTRACT

The power storage device includes a plurality of first power storage stacks, a plurality of second power storage stacks, a case, a first pressure release valve, a second pressure release valve, a first respiratory membrane, and a second respiratory membrane. The case has a first housing chamber, a second housing chamber, and an isolation wall for blocking. The first pressure release valve and the first respiratory membrane are provided in the first housing chamber. The second pressure release valve and the second respiratory membrane are provided in the second housing chamber.

### CROSS-REFERENCE TO RELATED APPLICATION

This application claims priority to Japanese Patent Application No. 2024-079227 filed on May 15, 2024, incorporated herein by reference in its entirety.

### BACKGROUND

### 1. Technical Field

The present disclosure relates to a power storage device.

### 2. Description of Related Art

For example, Japanese Unexamined Patent Application Publication No. 2023-47012 (JP 2023-47012 A) discloses a battery pack including a plurality of battery cells, a case that houses the battery cells, a pressure release valve provided to the case, and a respiratory membrane provided to the case. The case includes a lower case and an upper cover. The pressure release valve is provided on the upper cover, and the respiratory membrane is provided on the side wall portion of the lower case.

### SUMMARY

In the battery pack described in JP 2023-47012 A, when gas is generated from any one of the battery cells and the pressure in the case reaches a reference value, the gas is discharged through the pressure release valve. At this time, the gas spreads in the case. Therefore, the gas also comes into contact with the battery cells that do not generate the gas among the plurality of battery cells.

An object of the present disclosure is to provide a power storage device capable of reducing the number of power storage cells in contact with gas.

A power storage device according to an aspect of the present disclosure includes:
a plurality of first power storage stacks disposed side by side along a first direction;
a plurality of second power storage stacks that faces the first power storage stacks in a second direction and is disposed side by side along the first direction;
a case that houses the first power storage stacks and the second power storage stacks;
a first pressure release valve provided to the case;
a second pressure release valve provided to the case;
a first respiratory membrane provided to the case; and
a second respiratory membrane provided to the case.

The second direction is a direction orthogonal to both the first direction and a vertical direction.

The case includes:
a first housing chamber that houses the first power storage stacks;
a second housing chamber that houses the second power storage stacks; and
an isolation wall that isolates the first housing chamber from the second housing chamber.

The first pressure release valve and the first respiratory membrane are provided in the first housing chamber, and the second pressure release valve and the second respiratory membrane are provided in the second housing chamber.

According to the present disclosure, it is possible to provide the power storage device capable of reducing the number of power storage cells in contact with gas.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating a power storage device according to an embodiment of the present disclosure;

FIG. 2 is a perspective view schematically showing a state in which the upper cover is removed from the power storage device shown in FIG. 1;

FIG. 3 is a plan view schematically illustrating a state in which the upper cover is removed from the power storage device;

FIG. 4 is a cross-sectional view taken along IV-IV line in FIG. 3;

FIG. 5 is a diagram schematically showing a modification of the power storage device; and

FIG. 6 is a diagram schematically illustrating a modification of the power storage device.

### DETAILED DESCRIPTION OF EMBODIMENTS

Embodiments of the present disclosure will be described with reference to the drawings. In the drawings referred to below, the same or corresponding members are denoted by the same reference numerals.

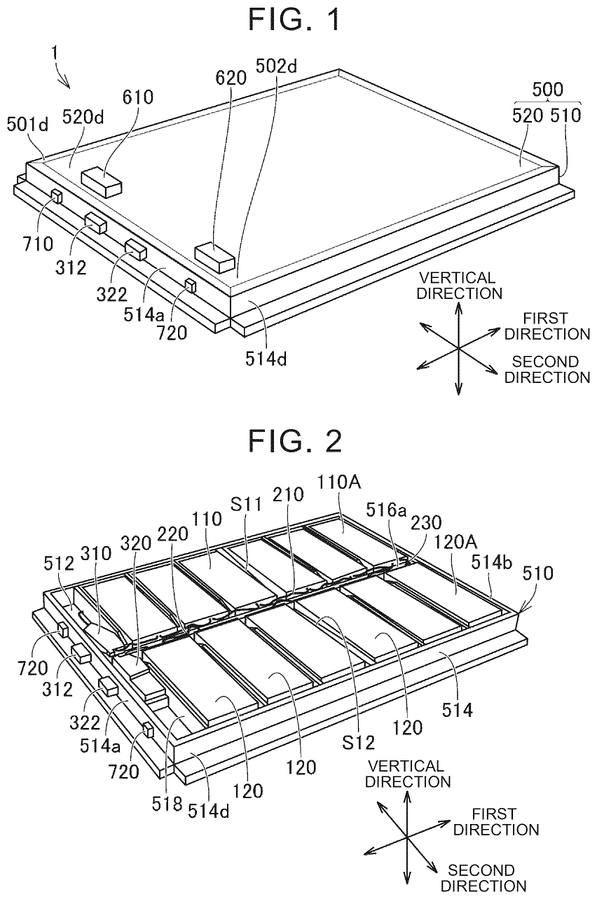

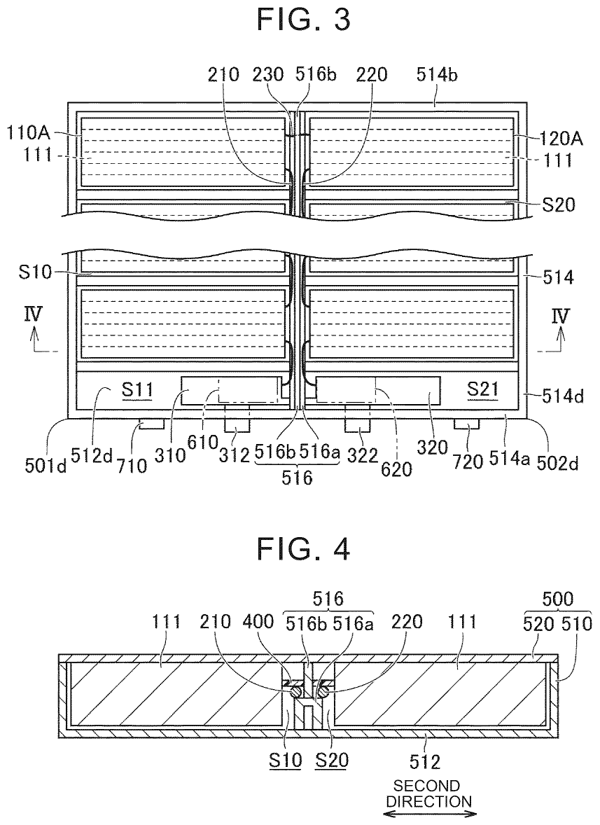

FIG. 1 is a perspective view schematically illustrating a power storage device according to an embodiment of the present disclosure. FIG. 2 is a perspective view schematically showing a state in which the upper cover is removed from the power storage device shown in FIG. 1. FIG. 3 is a plan view schematically illustrating a state in which the upper cover is removed from the power storage device. FIG. 4 is a cross-sectional view taken along IV-IV line in FIG. 3. The power storage device 1 is mounted on, for example, a bottom portion of a vehicle.

As illustrated in FIGS. 1 to 4, the power storage device 1 includes a plurality of first power storage stacks 110, a plurality of second power storage stacks 120, a first busbar 210, a second busbar 220, a third busbar 230, a first junction box 310, a second junction box 320, a cover plate 400, a case 500, a first pressure release valve 610, a second pressure release valve 620, a first respiratory membrane 710, and a second respiratory membrane 720.

The plurality of first power storage stacks 110 are arranged side by side in the first direction. In the present embodiment, the plurality of first power storage stacks 110 includes six first power storage stacks 110. However, the number of the first power storage stacks 110 is not limited to 6. Each of the first power storage stacks 110 is formed in a rectangular parallelepiped shape that is long in a second direction orthogonal to both the first direction and the vertical direction.

Each first power storage stack 110 includes a plurality of power storage cells 111 (see FIGS. 3 and 4). The plurality of power storage cells 111 are arranged in the first direction, for example. Note that the plurality of power storage cells 111 may be arranged side by side in the second direction. Each of the power storage cells 111 is formed in a flat rectangular parallelepiped shape. Examples of the power storage cells 111 include lithium ion batteries. Each of the power storage cells 111 may be constituted by an all-solid-state battery using a solid electrolyte. Each of the power storage cells 111 may include a safety valve provided at a position facing the upper cover 520, that is, on the upper surface of the housing of the power storage cell 111.

The plurality of second power storage stacks 120 are arranged so as to face the plurality of first power storage stacks 110 in the second direction and to be aligned in the first direction. In the present embodiment, the plurality of second power storage stacks 120 includes six second power storage stacks 120. However, the number of the second power storage stacks 120 is not limited to 6. The configuration of each second power storage stack 120 is the same as the configuration of the first power storage stack 110.

The first busbar 210 connects the pair of first power storage stacks 110 adjacent to each other in the first direction. The first busbar 210 is disposed between the plurality of first power storage stacks 110 and the plurality of second power storage stacks 120.

The second busbar 220 connects the pair of second power storage stacks 120 adjacent to each other in the first direction. The second busbar 220 is disposed between the plurality of first power storage stacks 110 and the plurality of second power storage stacks 120.

The third busbar 230 connects the first power storage stack (hereinafter, referred to as “first power storage stack 110A”) disposed on the outermost side in the first direction (for example, the front side in the front-rear direction of the vehicle) among the plurality of first power storage stacks 110 and the second power storage stack (hereinafter, referred to as “second power storage stack 120A”) disposed on the outermost side in the first direction (for example, the front side in the front-rear direction of the vehicle) among the plurality of second power storage stacks 120.

The first junction box 310 is disposed at a position facing the first power storage stack 110 disposed on the outermost side in the first direction (e.g., the rear side in the front-rear direction of the vehicle) of the plurality of first power storage stacks 110 in the first direction. More specifically, the first junction box 310 is opposed to the first power storage stack 110 disposed at an end of the plurality of first power storage stacks 110 opposite to the end where the first power storage stack 110A connected to the third busbar 230 is disposed. The first junction box 310 houses a relay, a fuse, and the like. The first junction box 310 includes a first connector 312. The first connector 312 protrudes outward in the first direction.

The second junction box 320 is disposed at a position facing the second power storage stack 120 in the first direction and spaced apart from the first junction box 310 in the second direction. The second junction box 320 houses a relay, a fuse, and the like. As shown in FIG. 3, in the present embodiment, the outer shape of the second junction box 320 is larger than the outer shape of the first junction box 310. The second junction box 320 includes a second connector 322. The second connector 322 protrudes outward in the first direction.

The cover plate 400 (see FIG. 4) covers the first busbar 210 and the second busbar 220 from above. The cover plate 400 is disposed between the plurality of first power storage stacks 110 and the plurality of second power storage stacks 120. The cover plate 400 extends along the first direction. The cover plate 400 is formed in a flat plate shape. The cover plate 400 is formed of an insulating member. The cover plate 400 is made of, for example, mica obtained by hardening natural inorganic minerals by hot pressing. The cover plate 400 has a function of shielding the gas ejected upward from any of the power storage stacks from coming into contact with each of the busbars 210, 220, 230. In FIG. 2 and FIG. 3, the cover plate 400 is not shown.

The case 500 houses the plurality of first power storage stacks 110, the plurality of second power storage stacks 120, the first busbars 210, the second busbars 220, the third busbars 230, the first junction box 310, the second junction box 320, and the cover plate 400. The case 500 includes a lower case 510 and an upper cover 520.

The lower case 510 opens upward. The lower case 510 includes a bottom wall 512, a peripheral wall 514, an isolation wall 516, and a partition portion 518.

The bottom wall 512 supports the respective power storage stacks 110, 120. The bottom wall 512 may be formed in a flat plate shape.

The peripheral wall 514 stands up from a peripheral edge portion of the bottom wall 512. The peripheral wall 514 surrounds the plurality of first power storage stacks 110 and the plurality of second power storage stacks 120. The peripheral wall 514 is formed in a substantially rectangular cylindrical shape. The peripheral wall 514 includes a first side wall 514a and a second side wall 514b.

The first side wall 514a is formed on a side (lower side in FIG. 3) opposite to a side where the plurality of first power storage stacks 110 and the plurality of second power storage stacks 120 are disposed with reference to the first junction box 310 and the second junction box 320. The first side wall 514a extends along the second direction. The first side wall 514a may be inclined toward the outer side in the first direction gradually toward the upper side, or may be perpendicular to the bottom wall 512.

The second side wall 514b faces the first side wall 514a in the first direction. The second side wall 514b faces the first power storage stack 110A and the second power storage stack 120A. The second side wall 514b extends along the second direction.

The isolation wall 516 partitions the plurality of first power storage stacks 110 and the plurality of second power storage stacks 120. The isolation wall 516 has a shape extending along the first direction. As illustrated in FIGS. 3 and 4, the isolation wall 516 includes a reinforcing portion 516a and a blocking portion 516b. In FIG. 2, the blocking portion 516b is not illustrated.

The reinforcing portion 516a is connected to the bottom wall 512. The reinforcing portion 516a extends in the first direction. The respective ends of the reinforcing portion 516a in the first direction are connected to the peripheral wall 514.

The blocking portion 516b is disposed on the reinforcing portion 516a. The respective end portions of the blocking portion 516b in the first direction are connected to the peripheral wall 514. The dimension of the blocking portion 516b in the second direction may be smaller than the dimension of the reinforcing portion 516a in the second direction. As shown in FIG. 4, the upper end of the blocking portion 516b is in contact with the upper cover 520. For example, the first busbar 210 is disposed on one side of the blocking portion 516b in the second direction, and the second busbar 220 is disposed on the other side of the blocking portion 516b in the second direction.

As shown in FIG. 3, the third busbar 230 penetrates the blocking portion 516b in the second direction. The blocking portion 516b is provided with a through hole through which the third busbar 230 is inserted. The gap between the third busbar 230 and the through-hole on the blocking portion 516b is filled with a member made of a heat-resistant material (such as heat-resistant silicone).

The partition portion 518 partitions between the first power storage stack 110 and the first junction box 310 and between the second power storage stack 120 and the second junction box 320. Each end portion of the partition portion 518 in the second direction is connected to the peripheral wall 514.

The upper cover 520 covers the plurality of first power storage stacks 110, the plurality of second power storage stacks 120, the first busbars 210, the second busbars 220, the third busbars 230, the first junction box 310, the second junction box 320, and the cover plate 400. The upper cover 520 houses a plurality of first power storage stacks 110, a plurality of second power storage stacks 120, a first busbar 210, a second busbar 220, a third busbar 230, a first junction box 310, a second junction box 320, and a cover plate 400 together with the lower case 510. The peripheral edge portion of the upper cover 520 is fixed to the upper end portion of the peripheral wall 514 by a bolt or the like.

The case 500 has a first housing chamber S10 and a second housing chamber S20.

The first housing chamber S10 houses a plurality of first power storage stacks 110. The first housing chamber S10 includes a portion of the bottom wall 512 on one side (left side in FIG. 3) of the isolation wall 516 in the second direction, a portion of the peripheral wall 514 on one side of the isolation wall 516 in the second direction, and a portion of the upper cover 520 on one side of the isolation wall 516 in the second direction.

The second housing chamber S20 contains a plurality of second power storage stacks 120. The second housing chamber S20 includes a portion of the bottom wall 512 on the other side (the right side in FIG. 3) of the isolation wall 516 in the second direction, a portion of the peripheral wall 514 on the other side of the isolation wall 516 in the second direction, and a portion of the upper cover 520 on the other side of the isolation wall 516 in the second direction.

The isolation wall 516 blocks the first housing chamber S10 from the second housing chamber S20.

The first junction box 310 is disposed in the first housing chamber S10. More specifically, the first housing chamber S10 includes a first space S11, and the first junction box 310 is disposed in the first space S11. The first space S11 is defined by the first defining portion 501d. The first defining portion 501d is constituted by a part of the first housing chamber S10. The first defining portion 501d defines a first space S11 on one side of the plurality of first power storage stacks 110 in the first direction. In the present embodiment, the first defining portion 501d includes a portion 512d of the bottom wall 512 on one side of the partition portion 518 in the first direction (see FIG. 3), a portion of the peripheral wall 514 on one side of the partition portion 518 in the first direction, a portion of the isolation wall 516 on one side of the partition portion 518 in the first direction, and a portion 520d of the upper cover 520 on one side of the partition portion 518 in the first direction (see FIG. 1).

The second junction box 320 is disposed in the second housing chamber S20. More specifically, the second housing chamber S20 includes the second space S21, and the second junction box 320 is disposed in the second space S21. The second space S21 is defined by the second defining portion 502d. The second defining portion 502d is constituted by a part of the second housing chamber S20. The second defining portion 502d defines the second space S21 at a position opposite to the first space S11 in the second direction on one side of the plurality of second power storage stacks 120 in the first direction and across the isolation wall 516. In the present embodiment, the second defining portion 502d includes a portion 512d of the bottom wall 512 on one side of the partition portion 518 in the first direction (see FIG. 3), a portion of the peripheral wall 514 on one side of the partition portion 518 in the first direction, a portion of the isolation wall 516 on one side of the partition portion 518 in the first direction, and a portion 520d of the upper cover 520 on one side of the partition portion 518 in the first direction (see FIG. 1).

The first pressure release valve 610 is provided in the first housing chamber S10 of the case 500. The first pressure release valve 610 releases the pressure in the first housing chamber S11. The first pressure release valve 610 opens when the pressure in the first housing chamber S11 becomes equal to or greater than the reference value. The first pressure release valve 610 is constituted by a check valve.

In the present embodiment, the first pressure release valve 610 is provided on the first defining portion 501d. More specifically, as shown in FIGS. 1 and 3, the first pressure release valve 610 is provided in a portion of the upper cover 520 above the first space S11. In FIG. 3, the first pressure release valve 610 is indicated by a two-dot chain line.

The second pressure release valve 620 is provided in the second housing chamber S20 of the case 500. The configuration of the second pressure release valve 620 is the same as the configuration of the first pressure release valve 610.

In the present embodiment, the second pressure release valve 620 is provided on the second defining portion 502d. More specifically, as shown in FIGS. 1 and 3, the second pressure release valve 620 is provided in a portion of the upper cover 520 above the second space S21. In FIG. 3, the second pressure release valve 620 is indicated by a two-dot chain line.

The first respiratory membrane 710 is provided in the first housing chamber S11 of the case 500. The first respiratory membrane 710 regulates the pressure in the first housing chamber S11 by allowing the passage of gas between the inside of the first housing chamber S11 and the outside of the case 500.

In the present embodiment, the first respiratory membrane 710 is provided on the first defining portion 501d. The first respiratory membrane 710 is preferably disposed on a side opposite to a side where the first power storage stack 110 is disposed with respect to the first pressure release valve 610. In the present embodiment, the first respiratory membrane 710 is provided on the first side wall 514a. Specifically, a through hole is provided in the first side wall 514a, and the first respiratory membrane 710 is attached to an outer surface of the first side wall 514a so as to cover the through hole.

The second respiratory membrane 720 is provided in the second housing chamber S21 of the case 500. The configuration of the second respiratory membrane 720 is the same as the configuration of the first respiratory membrane 710.

In the present embodiment, the second respiratory membrane 720 is provided on the second defining portion 502d. The second respiratory membrane 720 is preferably disposed on a side opposite to a side where the second power storage stack 120 is disposed with respect to the second pressure release valve 620. In the present embodiment, the second respiratory membrane 720 is provided on the first side wall 514a.

As described above, in the power storage device 1 according to the present embodiment, the pressure release valves 610, 620 and the respiratory membranes 710, 720 are provided in the housing chambers S10, S20 that are shut off from each other by the isolation walls 516. Therefore, for example, when the gas is discharged from the first power storage stack 110 disposed in the first housing chamber S10, the gas is discharged to the outside of the case 500 through the first pressure release valve 610. Therefore, the gases discharged from the first power storage stack 110 are prevented from contacting the second power storage stack 120 disposed in the second housing chamber S20.

Hereinafter, a modification of the above-described embodiment will be described.

### First Modification

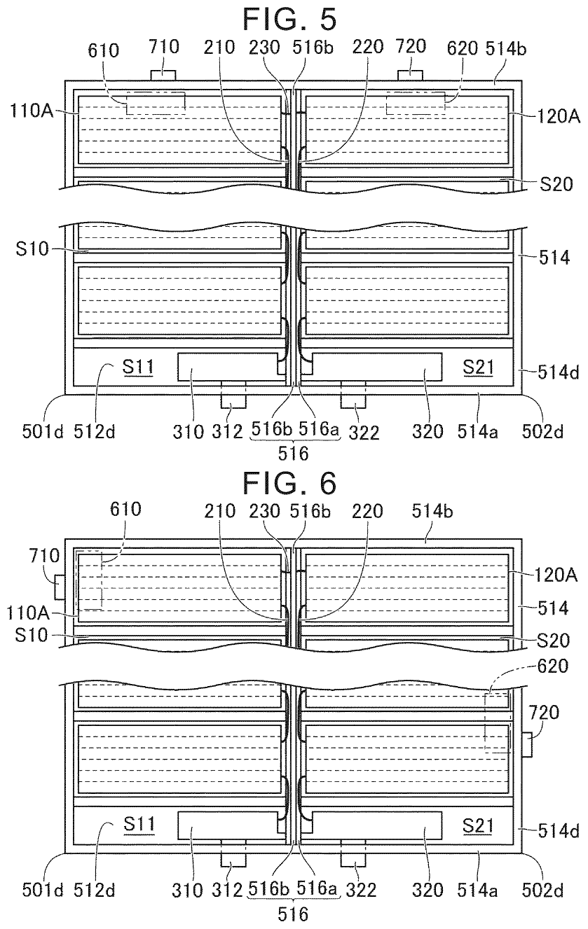

As shown in FIG. 5, the first pressure release valve 610 and the first respiratory membrane 710 may be provided in a portion of the first housing chamber S10 opposite to a side (upper side in FIG. 5) where the first junction box 310 is disposed in the first direction. Similarly, the second pressure release valve 620 and the second respiratory membrane 720 may be provided at a portion of the second housing chamber S20 opposite to a portion where the second junction box 320 is disposed in the first direction.

The “opposite-side portion” in the first housing chamber S10 includes a portion of the bottom wall 512 that vertically overlaps the first power storage stack 110A disposed on the outermost side in the first direction, a portion of the peripheral wall 514 that surrounds the first power storage stack 110A, and a portion of the upper cover 520 that vertically overlaps the first power storage stack 110A.

The “opposite-side portion” in the second housing chamber S20 includes a portion of the bottom wall 512 that vertically overlaps the second power storage stack 120A disposed on the outermost side in the first direction, a portion of the peripheral wall 514 that surrounds the second power storage stack 120A, and a portion of the upper cover 520 that vertically overlaps the second power storage stack 120A.

In the example shown in FIG. 5, the first pressure release valve 610 and the second pressure release valve 620 are provided in the upper cover 520. The first respiratory membrane 710 and the second respiratory membrane 720 are provided on the second side wall 514b of the peripheral wall 514.

In this embodiment, each junction box 310, 320 is located at a distance from each pressure release valve 610, 620 and each respiratory membrane 710, 720. Therefore, it is possible to prevent the junction boxes 310, 320 from being thermally affected by the gas discharged from the power storage stack.

### Second Modification

As illustrated in FIG. 6, the respiratory membranes 710, 720 may be provided at portions of the peripheral wall 514 facing each other in the second direction. This is the same for each pressure release valve 610, 620. However, in the example shown in FIG. 6, each pressure release valve 610, 620 is provided in the upper cover 520.

It will be understood by those skilled in the art that the exemplary embodiments described above are illustrative of the following aspects.

### First Aspect

The power storage device includes a plurality of first power storage stacks arranged side by side along the first direction.
A plurality of second power storage stacks opposed to the plurality of first power storage stacks in a second direction orthogonal to both the first direction and the vertical direction, and arranged to be aligned along the first direction;
A case for housing the plurality of first power storage stacks and the plurality of second power storage stacks,
A first pressure release valve provided in the case,
A second pressure release valve provided in the case,
A first respiratory membrane provided in the case,
A second respiratory membrane is provided in the case.
the case includes
A first housing chamber for housing the plurality of first power storage stacks,
A second housing chamber for housing the plurality of second power storage stacks, an isolation wall for blocking the first housing chamber from the second housing chamber is provided.
The first pressure release valve and the first respiratory membrane are provided in the first housing chamber.
The second pressure release valve and the second respiratory membrane are provided in the second housing chamber.

In this power storage device, a pressure release valve and a breathing membrane are provided in each of the housing chambers that are shut off from each other by the isolation wall. Therefore, even when the gas is discharged from the power storage stack in any of the storage chambers, the gas is prevented from coming into contact with the power storage stack stored in the other storage chambers.

### Second Aspect

The power storage device according to the first aspect includes a first junction box disposed in the first housing chamber.
A second junction box disposed in the second housing chamber, further comprising,
The first housing chamber has a first defining portion defining a first space on one side of the plurality of first power storage stacks in the first direction.
The second housing chamber has a second defining portion defining a second space on one side of the plurality of second power storage stacks in the first direction and at a position facing the first space in the second direction with the isolation wall interposed therebetween.
The first junction box is disposed in the first space.
The second junction box is disposed in the second space.
The first pressure release valve and the first respiratory membrane are provided in the first defining portion.
The second pressure release valve and the second respiratory membrane are provided in the second defining portion.

In this aspect, since the space near the junction box in each space is effectively utilized, it is possible to avoid an increase in the size of the case associated with the installation of each pressure release valve and each respiratory membrane.

### Third Aspect

The power storage device according to the first aspect includes a first junction box disposed at a position opposed to the plurality of first power storage stacks in the first housing chamber in the first direction.
The second housing chamber further includes a second junction box opposed to the plurality of second power storage stacks in the first direction and disposed at a position opposed to the first junction box in the second direction with the isolation wall interposed therebetween.
The first pressure release valve and the first respiratory membrane are provided in a portion of the first housing chamber on a side opposite to a side where the first junction box is disposed in the first direction.
The second pressure release valve and the second respiratory membrane are provided in a portion of the second housing chamber on a side opposite to a side where the second junction box is disposed in the first direction.

In this aspect, since each junction box is disposed at a position away from each pressure release valve and each respiratory membrane, it is suppressed that each junction box is thermally affected by the gas discharged from the power storage stack.

It should be understood that the embodiments disclosed herein are illustrative and non-restrictive in all respects. The scope of the present disclosure is defined by the terms of the claims, rather than the description of the embodiments described above, and includes all modifications within the scope and meaning equivalent to the terms of the claims.

What is claimed is:

1. A power storage device comprising:
a plurality of first power storage stacks disposed side by side along a first direction;
a plurality of second power storage stacks that faces the first power storage stacks in a second direction and is disposed side by side along the first direction, the second direction being a direction orthogonal to both the first direction and a vertical direction;
a case that houses the first power storage stacks and the second power storage stacks;
a first pressure release valve provided to the case;
a second pressure release valve provided to the case;
a first respiratory membrane provided to the case; and
a second respiratory membrane provided to the case, wherein
the case includes:
a first housing chamber that houses the first power storage stacks;
a second housing chamber that houses the second power storage stacks; and
an isolation wall that isolates the first housing chamber from the second housing chamber,
the first pressure release valve and the first respiratory membrane are provided in the first housing chamber, and
the second pressure release valve and the second respiratory membrane are provided in the second housing chamber.

2. The power storage device according to claim 1, further comprising:
a first junction box disposed in the first housing chamber; and
a second junction box disposed in the second housing chamber, wherein
the first housing chamber includes a first defining portion that defines a first space on one side of the first power storage stacks in the first direction,
the second housing chamber includes a second defining portion that defines a second space, the second space being defined on one side of the second power storage stacks in the first direction and at a position where the second space faces the first space in the second direction across the isolation wall,
the first junction box is disposed in the first space,
the second junction box is disposed in the second space,
the first pressure release valve and the first respiratory membrane are provided to the first defining portion, and
the second pressure release valve and the second respiratory membrane are provided to the second defining portion.

3. The power storage device according to claim 1, further comprising:
a first junction box disposed at a position where the first junction box faces the first power storage stacks in the first direction in the first housing chamber; and
a second junction box disposed at a position where the second junction box faces the second power storage stacks in the first direction in the second housing chamber and faces the first junction box in the second direction across the isolation wall, wherein
the first pressure release valve and the first respiratory membrane are provided at a portion of the first housing chamber that is opposite in the first direction to a side where the first junction box is disposed, and
the second pressure release valve and the second respiratory membrane are provided at a portion of the second housing chamber that is opposite in the first direction to a side where the second junction box is disposed.
